(19) United States
(12) Patent Application Publication
(10) Pub. No.: US 2018/0273056 A1
(43) Pub. Date: Sep. 27, 2018

(54) MOUNTING ARRANGEMENT FOR AN INTERIOR FURNISHING ELEMENT ON THE BODY OF A VEHICLE

(71) Applicant: SIEMENS AKTIENGESELLSCHAFT, MUENCHEN (DE)

(72) Inventor: GERHARD SCHMIDT, ESSEN (DE)

(21) Appl. No.: 15/989,451

(22) Filed: May 25, 2018

Related U.S. Application Data
(62) Division of application No. 14/782,018, filed on Oct. 2, 2015.

(30) Foreign Application Priority Data
Apr. 4, 2013 (DE) 10 2013 205 995.7

(51) Int. Cl. B61D 33/00; B61D 17/08; B60N 2/015; B61D 17/18

(52) U.S. Cl. CPC B61D 33/0078; B61D 17/08; B61D 17/18; B60N 2/01558

(57) ABSTRACT

A variable securing configuration for an interior equipment element on the body of a vehicle, particularly a passenger seat on the side wall of a rail vehicle, includes at least one body-side engagement device and a securing rail connected to the interior equipment element. In order to be able to produce such a securing configuration easily and cost-effectively, the body has recesses disposed at equal distances between one another in the longitudinal direction of the vehicle and at least one retention element of the engagement device engages with the recesses. The engagement device is connected to the securing rail in such a way that the securing rail with the interior equipment element is adjustable relative to the engagement device in the longitudinal direction of the vehicle by an adjustment path corresponding to at least the spacing between two successive recesses.

### CROSS-REFERENCE TO RELATED APPLICATION

This application is a Divisional of U.S. application Ser. No. 14/782,018, filed Oct. 2, 2015; which was a § 371 National Stage filing of International Application PCT/EP2014/055678, filed Mar. 21, 2014, which designated the United States; this application also claims the priority, under 35 U.S.C. § 119, of German Patent Application DE 10 2013 205 995.7, filed Apr. 4, 2013; the prior applications are herewith incorporated by reference in their entirety.

### BACKGROUND OF THE INVENTION

### Field of the Invention

The invention relates to a variable securing arrangement for an interior equipment element on the body of a vehicle, in particular a passenger seat at the side wall of a rail vehicle, having at least one body-side engagement device and having a securing rail which is connected to the interior equipment element.

A securing arrangement of this type is known from the German Offenlegungsschrift DE 10 2008 039 165 A1. In this securing arrangement, there is arranged on the side wall of the vehicle a C-profile rail which serves to receive sliding blocks, wherein a sliding block is provided in each case to fit an interior equipment element. The respective sliding block is an integral component of an engagement device which is supplemented by a clamping member which is screwed onto an outer pin of the sliding block and in this instance securely clamps a shaped member which is orientated in the direction toward the C-profile rail. This shaped member is connected to the interior equipment element.

### BRIEF SUMMARY OF THE INVENTION

An object of the invention is to provide a securing arrangement for an interior equipment element internally on the body of a vehicle, which arrangement can be produced in a comparatively simple and therefore cost-effective manner.

In order to solve this problem, the body has in the longitudinal direction of the vehicle recesses in which at least one retention element of the engagement device engages, and the engagement device is connected to the securing rail in such a manner that the securing rail can be adjusted with the interior equipment element in the longitudinal direction of the vehicle relative to the engagement device by an adjustment path which corresponds to at least the largest spacing of two sequential recesses.

A significant advantage of the securing arrangement according to the invention is that it in principle has no profile rail, in particular a C-profile rail, since the engagement device engages with the at least one retention element thereof directly from the front in the recesses; it is then also not necessary to fit in a C-profile rail from the side components of the securing device—such as sliding blocks in the known securing arrangement—from the end of the C-profile rail. It is advantageously possible as before, as a result of the adjustability of the engagement device, to arrange the interior equipment element in the desired position in the body in each case.

In the securing arrangement according to the invention, the recesses can be arranged with spacings of different sizes one after the other in the longitudinal direction of the vehicle, in order to comply with specific configurations of the respective body. If it is ensured that the adjustment path of the securing rail corresponds to at least the largest spacing of two sequential recesses, the interior equipment element can then be secured in the desired position in each case in a simple manner. As long as the construction of the body permits, it is particularly advantageous for the recesses to be arranged with the same spacing with respect to each other.

Inter alia for reasons of stability, it may be advantageous for the recesses to be accommodated in a longitudinal rail on the body in the securing arrangement according to the invention.

It is further considered to be advantageous for the engagement device to be connected to the securing rail in such a manner that the securing rail can be adjusted in a stepless manner. In this instance, the position of the interior equipment element can be roughly predetermined by selecting one or more adjacent recesses and precisely adjusted by the stepless adjustment of the securing rail.

Inter alia in order to achieve relatively short assembly times, it is considered to be advantageous to connect the engagement device to the securing rail in such a manner that the securing rail can be adjusted in a stepped and stepless manner. It is thereby possible to determine the interior equipment element first in a rough manner by selecting specific recesses and subsequently to adjust the securing rail in a less rough manner in a correspondingly stepped manner with the interior equipment element; finally, the stepless adjustment of the securing rail is then carried out with the interior equipment element.

In a particularly advantageous embodiment of the securing arrangement according to the invention, the engagement device is provided in the manner of a claw with lateral narrowed portions for fitting by means of pivoting and retention in the recesses. The fitting of the engagement device is very simple and consequently cost-effective.

In this embodiment of the securing arrangement according to the invention, a sliding block is advantageously located in the engagement device and the securing rail is connected to the sliding block by means of a connection element which is guided through a securing hole of the securing rail. The connection element is advantageously a screw.

In order to achieve a stepped adjustment of the securing rail in a simple manner with the securing arrangement according to the invention, additional securing holes are arranged in a horizontal row with the securing hole of the securing rail. In this instance, the holes may have different spacing with respect to each other.

However, a securing rail in which the securing holes each have a hole spacing from each other of the same size is adequate and can be readily produced. In this instance, the hole spacing of the securing holes is advantageously a fraction of the spacing of the recesses.

In order to achieve a simple stepless adjustment of the securing rail, the engagement device has elongate holes with a spacing which corresponds to the hole spacing of the securing holes.

The securing rail may be constructed differently. It is considered to be advantageous for the securing rail to be constructed as a profile rail and to engage over the longitudinal rail. In this instance, it is advantageous, in order to increase the travel comfort or for thermal and mechanical decoupling of the interior equipment element from the body, to arrange a resilient intermediate layer between the longitudinal rail and the profile rail.

For the same reason, there is located in the narrowed portions of the engagement device a resilient sleeve for receiving the engagement device in a positive-locking manner in the respective recess.

In another advantageous embodiment of the securing device according to the invention, the longitudinal rail has an upper carrier face which is accessible from the inner side of the body for one side of the securing rail and at least one connection member of the engagement device engages below the longitudinal rail with one end and is in abutment with the other end thereof with the securing rail.

An advantage of this embodiment of the securing arrangement according to the invention is that the longitudinal rail can be constructed in a comparatively simple manner since it only has to have an upper carrier face for the securing rail and lateral recesses. This also enables relatively simple fitting of the interior equipment element to the longitudinal rail since, to this end, the securing rail simply has to be placed at the top on the longitudinal rail and the connection member has to be arranged so as to engage below the longitudinal rail and in this instance at least one retention element has to be introduced into a recess; finally, a connection of these components to the interior equipment element further has to be carried out.

In this instance, the longitudinal rail advantageously has a U-shaped profile, is fitted to the body so as to be open in an upward direction and forms at the upper side with a member the carrier face for the securing rail. However, other profiles for the longitudinal rail may also be considered.

The securing rail may also be constructed differently in the securing arrangement according to the invention. Advantageously, the securing rail is constructed in a hook-like manner at one side thereof and engages with the hook-like side thereof from the upper side in the U-shaped profile of the longitudinal rail; with the assembly side thereof which faces away from the hook-like side, the securing rail is secured to the interior equipment element.

In this instance, it is also advantageous, for thermal and mechanical decoupling of the interior equipment element from the body, for a resilient intermediate layer to be located below the hook-like side of the securing rail.

With a corresponding advantage being afforded, a resilient pad (13) is arranged between the longitudinal rail and one side of the securing rail.

It is further advantageous, in this embodiment of the securing arrangement according to the invention, for the engagement device to have at least one retention element on a rail-like carrier member which is retained between the securing rail and the connection element and for the at least one retention element to engage in the recesses of the body.

The rail-like carrier member is advantageously fitted to the securing rail together with the connection member.

In order to also ensure with this embodiment of the securing arrangement according to the invention a stepless adjustment of the securing rail with respect to the engagement device, the rail-like carrier member has elongate holes which extend in the longitudinal direction thereof and the elongate holes have a minimum length which corresponds to the spacing of two adjacent recesses; securing elements protrude into the elongate holes.

Other features which are considered as characteristic for the invention are set forth in the appended claims.

Although the invention is illustrated and described herein as embodied in a mounting arrangement for an interior furnishing element on the body of a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side view of an embodiment of the securing arrangement according to the invention with stepped and stepless adjustment possibility of a securing rail on the interior equipment element of a vehicle with respect to the carriage thereof;

FIG. 2 is a section along the line II-II according to FIG. 1;

FIG. 3 is a section along the line III-III according to FIG. 2;

FIG. 4 is a partial section and a partial side view of another embodiment of the securing arrangement according to the invention with a stepless adjustment possibility for a securing rail on the interior equipment element of a vehicle with respect to the carriage thereof, of a side wall rail with an engagement device;

FIG. 5 is a section along the line V-V according to FIG. 4; and

FIG. 6 is a section along the line VI-VI according to FIG. 4.

### DESCRIPTION OF THE INVENTION

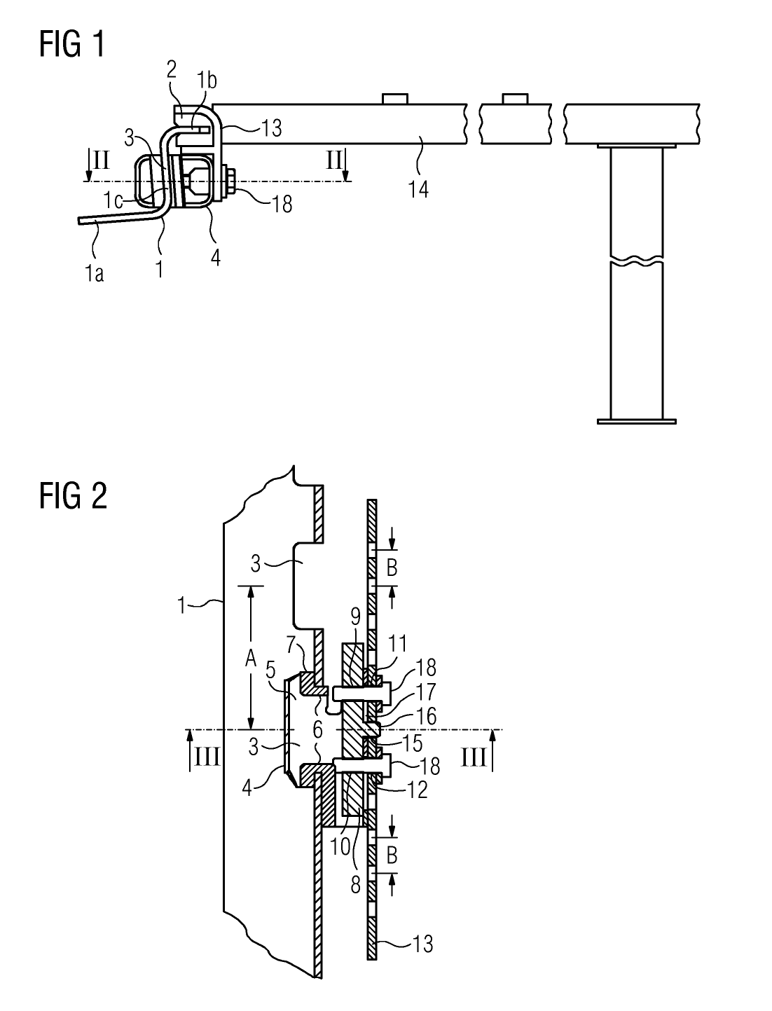

FIG. 1 shows a longitudinal rail 1 which is connected in a manner not illustrated to a side wall of a body of a rail vehicle at the end 1a thereof. The longitudinal rail 1 has an S-shaped profile, which forms at an upper end of the longitudinal rail 1 a support face 1b for a resilient intermediate layer 2. The longitudinal rail 1 has in the central region 1c thereof recesses 3 which are arranged one behind the other with a predetermined hole spacing A so as to form a horizontal row, as can be seen in particular in FIG. 2.

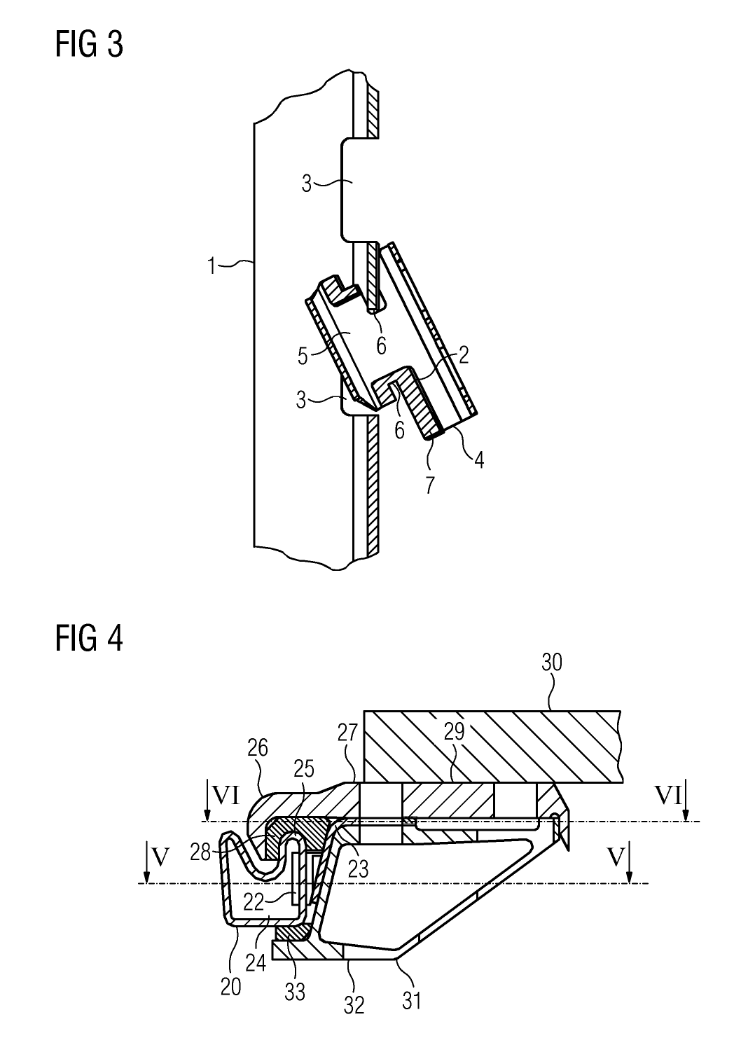

In a recess 3, in the context of a first rough positioning—as FIG. 2 in turn shows in a particularly clear manner—there is fitted a retention element 4 of an engagement device 5 which is provided for this purpose with narrowed portions 6 (cf. also FIG. 3). In the narrowed portions 6 there is a resilient sleeve 7 which not only ensures secure fitting of the retention element 4 of the engagement device 5 in the recess 3 but also makes it more difficult to transmit mechanical shocks from the side wall of the vehicle in a desired manner.

The engagement device 5 further has a sliding block 8 which is provided with threaded holes 9 and 10. These threaded holes 9 and 10 are provided with a spacing which corresponds to the spacing between a securing hole 11 and the next-but-one additional securing hole 12 in a securing rail 13 of an interior equipment element 14 as FIG. 1 shows in particular. A carrier pin 16 of the sliding block 8 engages in an additional securing hole 15. The securing hole 11 and the additional securing holes 12 and 15 each have a hole spacing B from each other which constitutes a fraction of the hole spacing A of the recesses 3. In this manner, it is possible to orientate the securing rail 13 with the interior equipment element 14 with respect to the longitudinal rail 1 in a finer manner than was possible with the rough orientation. Finally, a final, precise, stepless orientation is further possible by the retention element 4 being provided with elongate holes 17 in a region between the sliding block 8 and the securing rail 13.

The retention element 4 is constructed in a substantially rectangular manner in cross section and is almost enclosed—see FIG. 1. This figure also clearly shows that the securing rail 13 engages over the resilient intermediate layer 2 on the longitudinal rail 1 with the interior equipment element 14 being retained, whereby the interior equipment element 14 is resiliently supported. FIG. 1 further shows that connection elements in the form of screws 18 are screwed into the sliding block 4 and in this instance clamp the retention element 4 to the longitudinal rail 1 and the securing rail 13.

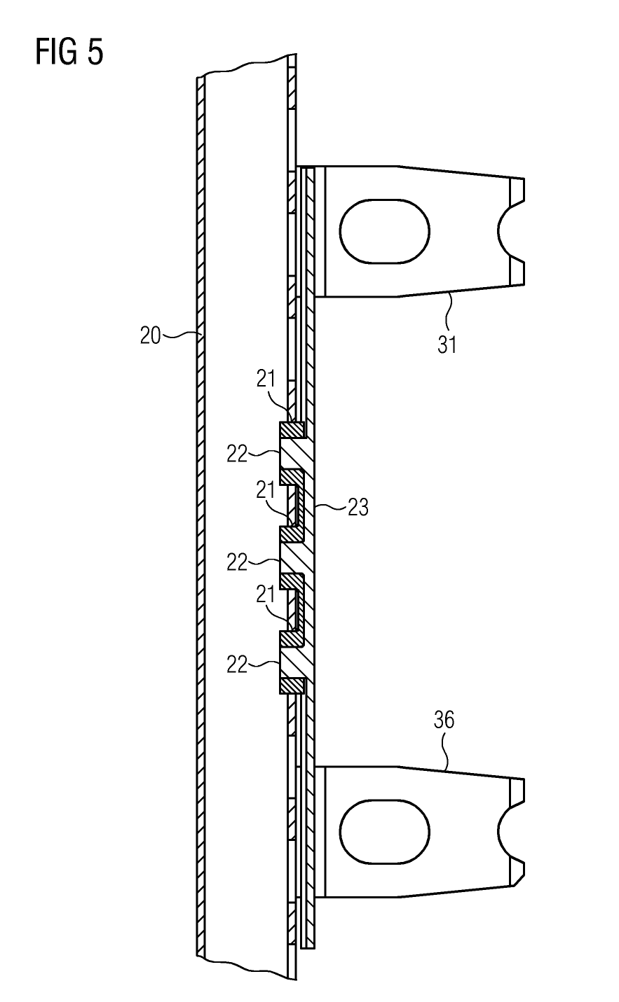

FIG. 4 shows that a longitudinal rail 20 which is fitted to a side wall (not illustrated) of a body of a vehicle which is also not illustrated has a U-shaped profile and is fitted to the side wall in such a manner that the profile is open in an upward direction. The longitudinal rail 20 has lateral recesses 21 which—as shown in FIG. 5—are arranged with the same spacing from each other.

In the embodiment illustrated, retention elements 22 which are constructed as pins engage in three of the recesses 21 on a rail-like carrier member 23 of an engagement device 24.

As can further be seen in FIG. 4, the longitudinal rail 20 forms with the right-hand member thereof in FIG. 1 an upper carrier face 25 for an end 26 of a securing rail 27. The securing rail 27 is to this end constructed in a hook-like manner at one end 26 thereof. Between the hook-like end 26 and the longitudinal rail 20 is a resilient intermediate layer 28 for thermal and mechanical decoupling. With the other assembly end 29 thereof, the securing rail 27 is connected, preferably screwed, to an interior equipment element 30, for example, a passenger seat, of the vehicle which is not shown.

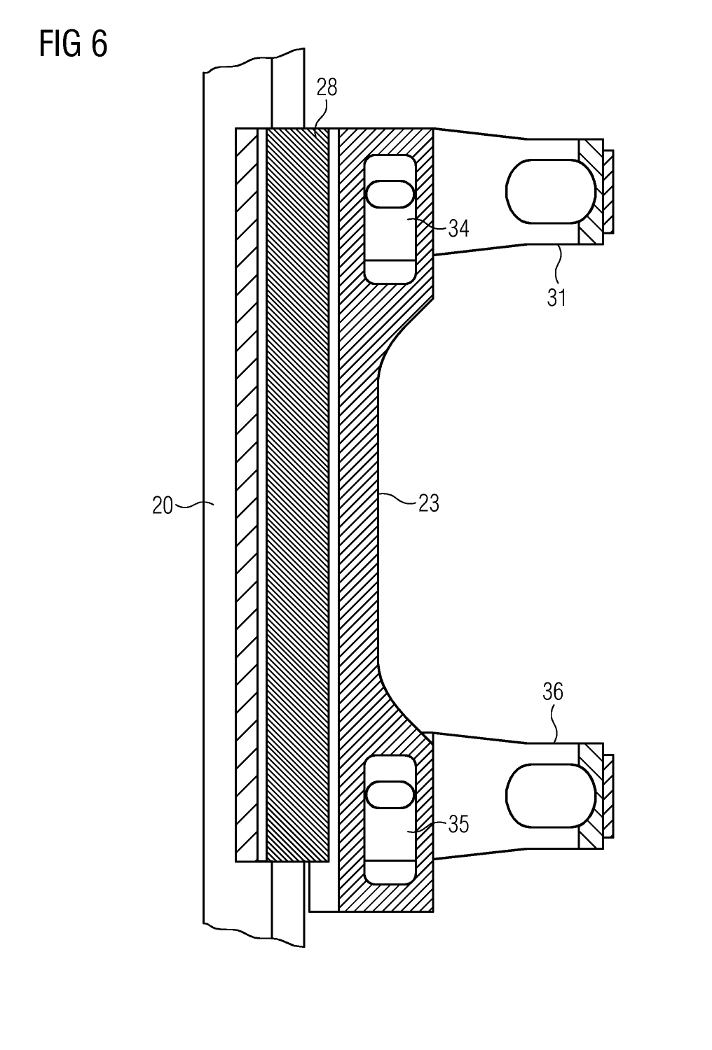

FIGS. 4 and 5 further show that a connection member 31 is present which engages below the longitudinal rail 20 with one end 32 thereof. In a state placed in-between in this instance is a resilient pad 33 which is also used for the thermal and mechanical decoupling of the longitudinal rail 20 and the interior equipment element 30. The connection member 31, in a manner not illustrated, is screwed together with the rail-like carrier member 23 and the securing rail 27 to the interior equipment element 30. In this instance, elongate holes 34 and 35 which extend in the longitudinal direction of the vehicle in the rail-like carrier body 23 (cf. FIG. 6) enable stepless adjustment of the interior equipment element 30 with respect to the respective position of the retention elements 22 in the longitudinal rail 20.

FIG. 5 shows that, in the securing arrangement illustrated, the interior equipment element 30 which cannot be seen in this instance is fitted not only with a connection member 31 in accordance with FIG. 4, but also with another connection member 36 to the longitudinal rail 20. In this instance, the connection is carried out in the region of the additional connection member 36 on the longitudinal rail 20 in the same manner as has been described above with reference to FIG. 4.

1. A variable securing configuration for an interior equipment element on a vehicle body, the securing configuration comprising:
a securing rail connected to the interior equipment element; and
at least one body-side engagement device having at least one retention element engaging in recesses formed in the vehicle body in a longitudinal direction of the vehicle and defining a largest spacing between a sequential two of said recesses;
said at least one engagement device being connected to said securing rail in a manner permitting said securing rail to be adjustable with said interior equipment element in the longitudinal direction of the vehicle relative to said engagement device by an adjustment path corresponding to at least said largest spacing between said two sequential recesses.

2. The securing configuration according to claim 1, wherein said recesses are spaced apart by the same mutual spacing.

3. The securing configuration according to claim 1, which further comprises a longitudinal rail disposed on the vehicle body, said recesses being accommodated in said longitudinal rail.

4. The securing configuration according to claim 1, wherein said at least one engagement device is connected to said securing rail in a manner permitting said securing rail to be adjusted steplessly.

5. The securing configuration according to claim 3, wherein:
said securing rail has an end;
said longitudinal rail has an upper carrier face for said end of said securing rail and is accessible from an inner side of the vehicle body; and
said at least one engagement device has at least one connection member with one end engaging below said longitudinal rail and another end in abutment with said securing rail.

6. The securing configuration according to claim 5, wherein said longitudinal rail has a U-shaped profile, is fitted to the vehicle body so as to be open in an upward direction and has an upper side with a member forming said carrier face for said securing rail.

7. The securing configuration according to claim 6, wherein said end of said securing rail is hook-shaped, said hook-shaped end engages from above in said U-shaped profile of said longitudinal rail, and said securing rail has an assembly end facing away from said hook-shaped end and being secured to said interior equipment element.

8. The securing configuration according to claim 7, which further comprises a resilient intermediate layer located below said hook-shaped end of said securing rail.

9. The securing configuration according to claim 5, which further comprises a resilient pad disposed between said longitudinal rail and one end of said securing rail.

10. The securing configuration according to claim 5, wherein said at least one engagement device has a rail-shaped carrier member retained between said securing rail and said connection member and at least one retention element disposed on said rail-shaped carrier member, and said at least one retention element engages in said recesses of the vehicle body.

11. The securing configuration according to claim 10, wherein said rail-shaped carrier member is fitted to said securing rail together with said connection member.

12. The securing configuration according to claim 10, wherein:
said rail-shaped carrier member has elongate holes extending in a longitudinal direction of said rail-shaped carrier member;
said elongate holes have a minimum length corresponding to a spacing between an adjacent two of said recesses; and
securing elements protrude into said elongate holes.

13. The securing configuration according to claim 1, wherein the interior equipment element is a passenger seat at a side wall of a rail vehicle.
